(19) United States
(12) Patent Application Publication
(10) Pub. No.: US 2004/0232727 A1
(43) Pub. Date: Nov. 25, 2004

(54) Automobile body having improved aerodynamic shape

(76) Inventors: Vitaliy L. Lyakir, Brooklyn, NY (US); Alla Litouchenko, Needham, MA (US); Dmitry Denikin, Bulger, PA (US)

Correspondence Address: ALLA LITOUCHENKO, 855 GREAT PLAIN AVENUE, NEEDHAM, MA, 02492, US

(21) Appl. No.: 10/443,169

(22) Filed: May 23, 2003

(51) Int. Cl. B62D 35/00

(52) U.S. Cl. 296/185.1

(57) ABSTRACT

Automobile body performing with reduced aerodynamic lift while speeding, and therefore having a fuselage of a parallelogram shape where the fuselage is made with roof projected backward and also having its body rear plate, or otherwise rear half of the car's bottom plate, slanted upward toward its car's rear end to create a body of parallelogram shape at the side section. Reducing aerodynamic lift which normally occurs while a car is moving at a high speed, will happen when separation of air flow around the top and bottom of the car's body will distributed with less than a standard difference in length, speed, and air density of both parts, and will result in more or less equality in air pressure occurring around the top and bottom of the automobile fuselage.

### CROSS-REFERENCE TO RELATED APPLICATIONS

U.S. patent documents:

U.S. Pat. No. 4,489,972

U.S. Pat. No. 5,505,507

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

The invention pertains to the automobile fuselage design field of endeavor, and more specifically to a car's body aerodynamic improvement devices. Because the air resistance to an object moving through, a regular pontoon-shaped automobile body cuts the frontal air flow, the way where two unequal major air flows are running around top and bottom of the fuselage. Due the comparative flatness of this fuselage on the bottom side, the bottom airflow is shorter than the upper one and runs slower. Hence, an air density and pressure below the automobile bottom exceeds the same above the roof. Occurrence of an aerodynamic lift (or force) reduces vehicle stability by pulling a moving object against its gravitational force proportionally to the speed of its movement. To make an air pressure on both parts of the car's fuselage more even, one shall have a more symmetrical shape. For instance, the body shaped as a parallelogram in its side cross-section will create desirable air pressure equality.

A conventional fuselage rear end design (box, sloping box, fastback, notch back models, etc.) is not very effective in reducing the previously described aerodynamic lift. Due to the wind attacking a compact fuselage at a higher angle than a larger one, a higher aerodynamic lift occurred in the first case. As a result, a typical automobile of small classes has lower speed/motor power ratio, higher wind resistance sensitivity, and comparatively uncertain stability due to a higher ratio between cars speed and wheels/road contact comparing to larger car models.

The lack of space in the rear part of a passenger compartment of typical small classes' fuselage demands adult passengers to bend their neck. This make rear seats of those uncomfortable and affect people heals. Also, the compartment of this type of design has low efficiency of inner space usage and has a high drag coefficient.

Various designs to reduce front airflow resistance, drag coefficient, side-wind sensitivity are known, such as under U.S. Pat. Nos. 4,489,972 and 4,505,507. Yet a notable reduction of aerodynamic lift was achieved either by flattening of the automobile fuselage (which also limits an observation angle), or by using a spoiler of large size for increasing an airflow pressure on the fuselage's rear top (and getting an increased air drag coefficient).

### BRIEF SUMMARY OF THE INVENTION

The present invention is intended as an aerodynamic lift decreasing vehicular body of a parallelogram shape in side section of the type described introductory which exhibits the lowest possible aerodynamic force in order to increase contact with the road surface of the type of vehicle in question.

The invention attains this objective in that the front-upper surface of the fuselage is made roughly equal in length to the bottom-rear surface in such a way that air flowing both ways around a car's body gets equal speed, density and occur equal pressure on the fuselage surface from both sides.

The point of departure for the present invention is the fact, which is in itself known, that an air flow resisting a moving car became separated by its fuselage, and here a value of an air pressure occurred on each part of the vehicle's surface is in direct proportion to the speed of air flow contacting this part.

Air pressure of this kind occurs, in particular, around conventional pontoon fuselage wherein uneven airflow separation causes a resulting air pressure contrary to gravitation. The present invention will allow a fuselage to create an equal vertical airflow separation along the surface of this parallelogram-shaped body to eliminate an aerodynamic lift or perhaps to obtain a negative direction of aerodynamic lift to increase, along with a gravitational force, the moving vehicle's stability.

This fuselage quality can be obtained by increasing in length its bottom-rear (L1) surface and simultaneous decreasing in length a front-upper surface (L2) to make the last equal or otherwise smaller than the other.

Advantages of this invention are:

Optimization of vehicle dynamic stability due to the increase of contact between the vehicle wheels and road surface, where faster car movement will show a higher advantage of this invention in comparison to conventional car models.

A more comfortable body position will be allowed in the rear passenger chair, because new seats introduce larger room for people's back and neck, to avoid a banding position.

A parallelogram shaped fuselage involved in a collision by getting stroked into its back by a following passenger car's radiator allows the first to slide on top of the other one. Sliding along the car body's rear plate will also reduce a Direct Striking Force and bounce it away from passenger seats. Imaginatively possible overturning would be more acceptable over a car rear compartment's banding or crushing.

Described herein above, the sliding feature of the parallelogram shaped fuselage imposes a limit on the collision forces value. Reverse ratio between the improved vehicle's rear plate durability and its weight, suggest possible achievement of such a value of the first that any collision forces value exceeding this value of the improved vehicle weight, will lift this vehicle higher up, instead of to cause banding the fuselage rear plate.

### BRIEF DESCRIPTION OF THE SEVERAL VIEWS OF THE DRAWING

An embodiment of the invention will be better understood by referring to the following description taken in conjunction with the accompanying drawings, in which identical reference numerals identify similar elements, and in which:

Side section of typical pontoon fuselage at FIG. 1 schematically illustrates an aerodynamic lifting force occurring to a car body

Side section of improved fuselage at FIG. 2 schematically illustrates aerodynamic lift elimination

Schematic side view of typical pontoon fuselage rear compartment FIG. 3 illustrates passenger's backbone position

Schematic side view of an improved fuselage rear compartment FIG. 4 illustrates improved passenger's backbone position

FIG. 5 shows the improved fuselage being stroked from behind, slides along its curvature on top of this radiator behind

Collision forces resolution on FIG. 6 shows redistribution of acting forces along the improved fuselage's surface

FIG. 7 indicate typical location and size of conventional passenger compartment's volume used for secondary function (i.e. luggage place, accident body buffer zone)

FIGS. 8, 8a, and 8b indicate improved passenger compartment volume used for secondary functions

FIGS. 9, 9a and 9b are sketches showing preferable embodiments of this invention

### DETAILED DESCRIPTION OF THE INVENTION

The present invention is an automobile fuselage designed to make the uniform physical value of the air flow distribution occurring around the top and bottom of this fuselage, also forming slanted upward toward car's back, the rear end plate, or otherwise the bottom plate's rear, with rear seats to support passengers' back at angle accordingly human body anatomy curvature, or otherwise to serve as a trunk.

The schematic side section view of a typical fuselage, FIG. 1 show the airflows L1 and L2 from the imaginary point of separation D, to the imaginary point of alienation U. The value of air pressure F1 on the top and F2 on the bottom of the fuselage shall be in the direct ratio to the value of an air density P over the fuselage area A; and similarly at the inverse ratio to the flows speed V, and to the fuselage area A with its length of air flow L, from area of flows separation to the area of their alienation (time T is equal for both):

P=F/A; Where:

L1>L2; then: A1>A2; also: V1>V2; (L=VT; T1=T2;)

P1<P2; accordingly Bernoulli's Principle; Therefore: F2>F1;

Resulting force: Fa=F2−F1; this Fa represents an Aerodynamic Lifting Force (Aerodynamic Lift, which affect with minimizing contact of a vehicle with the road surface)

This force must be in an equilibrium with the gravitation G and with resistange of the road surface Fr:

Fa−G+Fr=0; or: Fr=G−Fa;

A similar drawing on FIG. 2 and calculation for an improved fuselage will show elimination of an Aerodynamic Lift:

L1=L2; then: V1=V2; similarly: P1=P2; therefore: F2=/F1/; or: Fa=F2−F1=0;

In this case:/Fr/=G;

A negative Aerodynamic Lift may occur when due to the appropriate car's body configuration, a fuselage top will be designed more flat than a bottom:

L1<L2; (T1=T2;) then: V1<V2; hence: P1>P2; therefore: F2<F1;

/Fr/=G+/Fa/;

A passenger's body position inside a typical passenger compartment, with a backbone in tension, is shown on FIG. 3. An improvement of mentioned herein above is shown on FIG. 4.

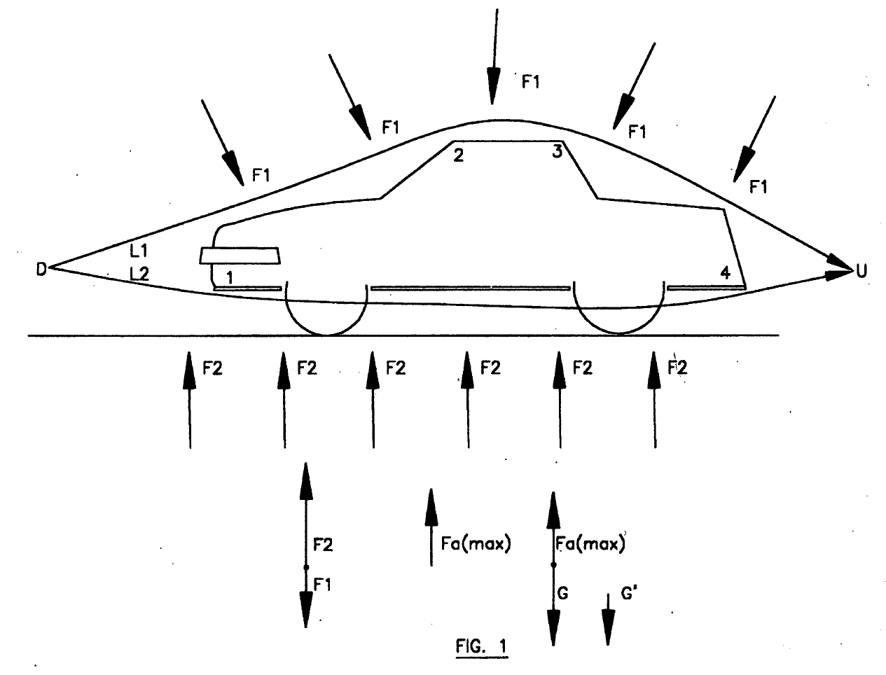

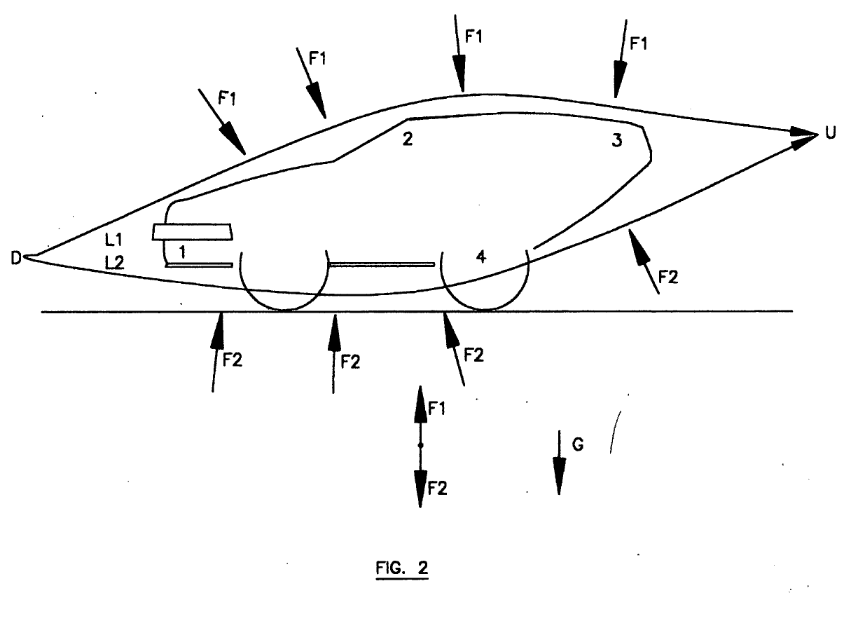

A collision on FIG. 5 shows movement direction while the improved fuselage slides on top of the radiator striking from behind.

A collision forces resolution on FIG. 6, shows a collision vector Fc founding a rolling resistance Rr on the sloped (angle Q) area at the fuselage surface AB and being channeling by gravitation G and a road surface resistance Fr, resulting in bouncing down-forward as F and up-forward as F′. (Fc=F+F′); A fuselage sliding resistance Rs is the smallest force to counteract against an attack from the rear in case the car's body durability Em will be large enough to exceed one. (Rs×G<Em)

F parallel to AB; F′ perpendicular to AB; where AB is the fuselage rear surface slanted at an angle Q, the way its top is projected toward its back.

After striking surface AB, the Collision Force vector Fc is channeled toward vector F to slide along AB (due to the sliding resistance Rs is the smallest force on the way). Rs<mE, where mE represents a car body's rear plate durability.

Then F′, a part of Fc perpendicular to AB (Fc−F=F′), during the time of the collision(t) is distributed along surface AB, minimizing the force's F′ impact on the initial point of contact with the fuselage.

Therefore:

To exclude a possibility of the vehicle's rear plate crush, its durability (Em) must be strong enough to withstand the maximal applied force F′. The fuselage meterial's ellasticity must to exceed the value of the improved fuselage weight:

Em>G;

Any collision force will only lift the improved fuselage higher up. Since the vector of a Collision Force (Fc) will be on a sharp anle to the surface of the car body's rear plate, it will never crush a fuselage:

Fc=F′ sin Q;

F′=Fc cscQ;

Em>Fc(t)cscQ;

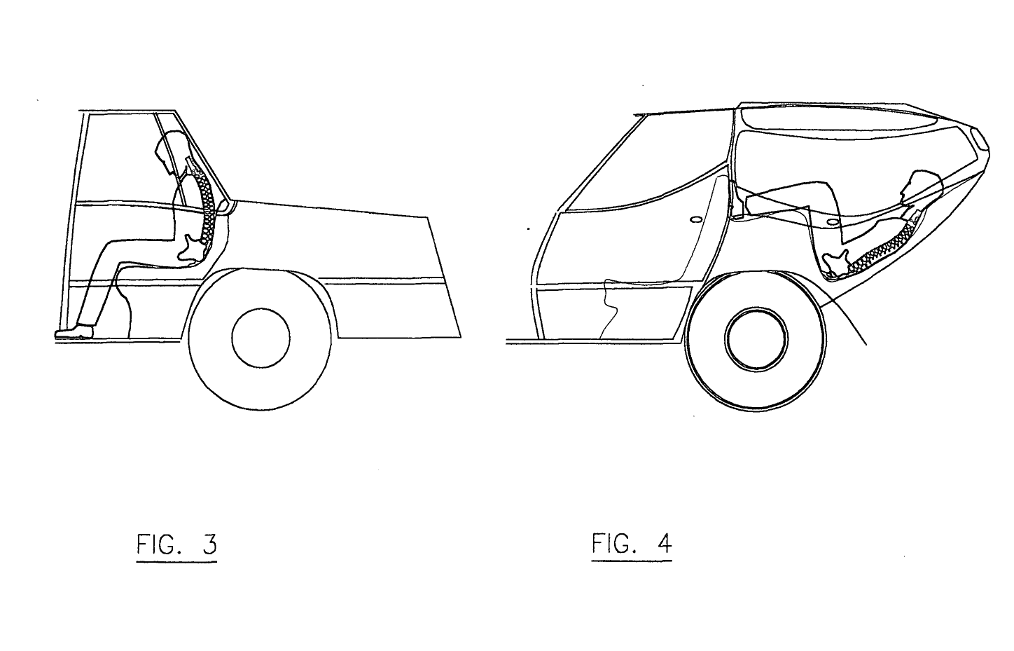

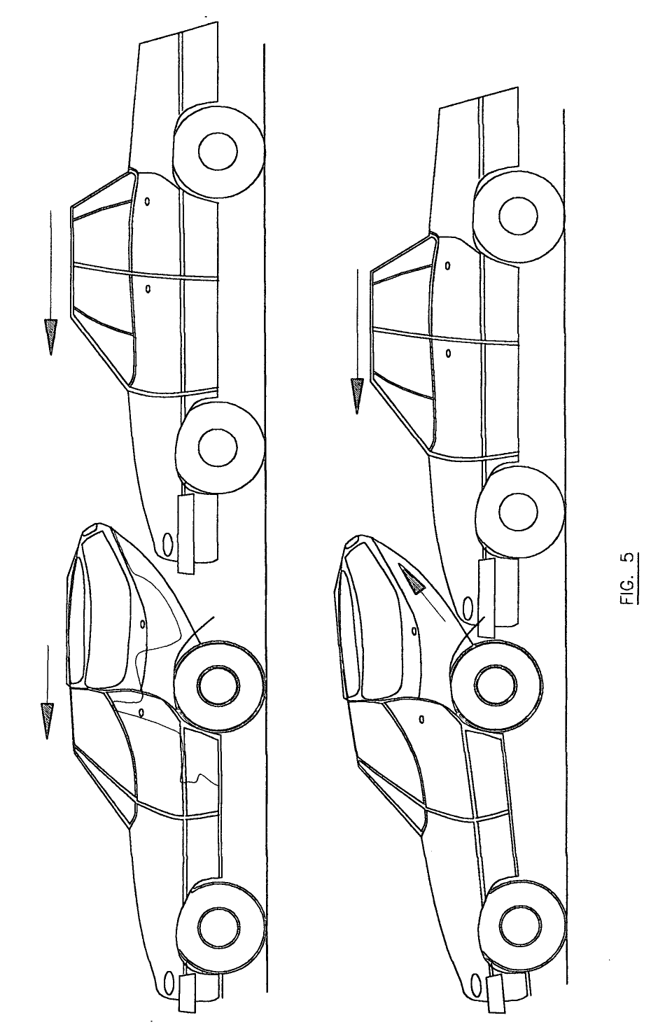

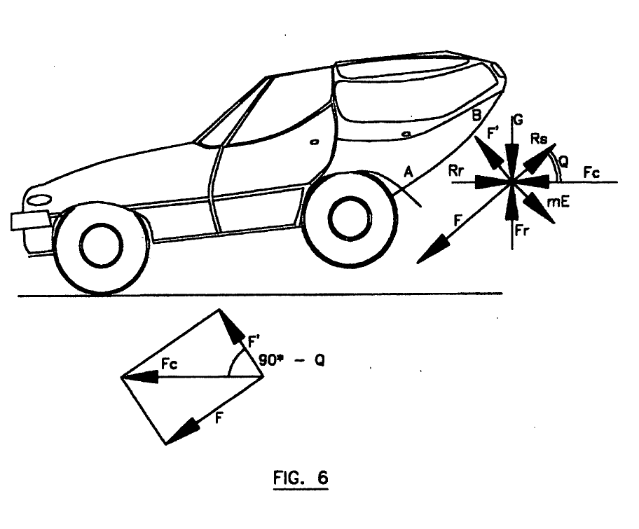

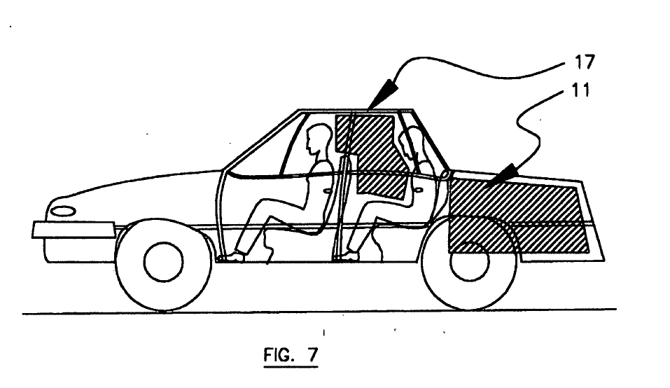

FIG. 7, 8, 8a and 8b illustrate the advantage of car's interior space usage in the improved fuselage over existing types.

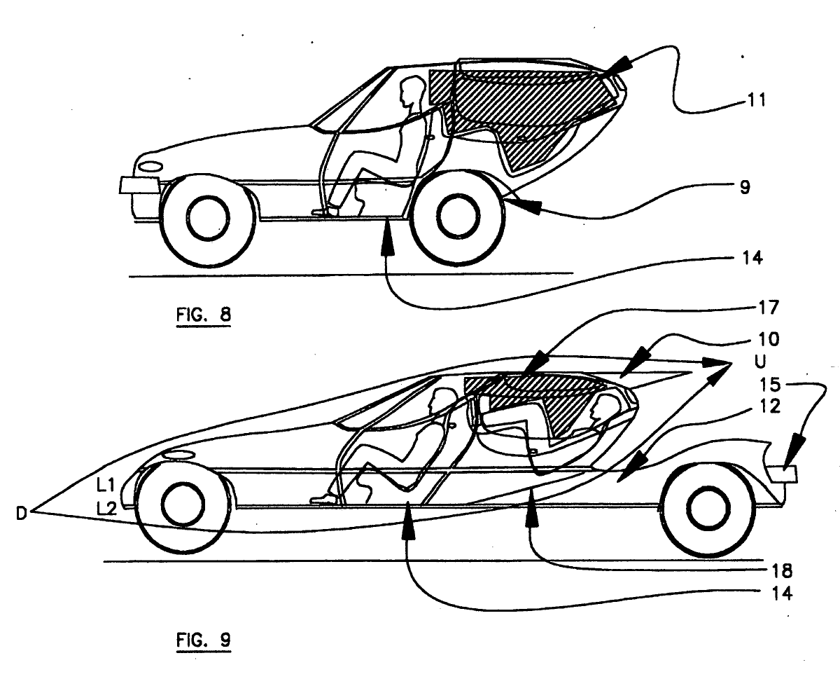

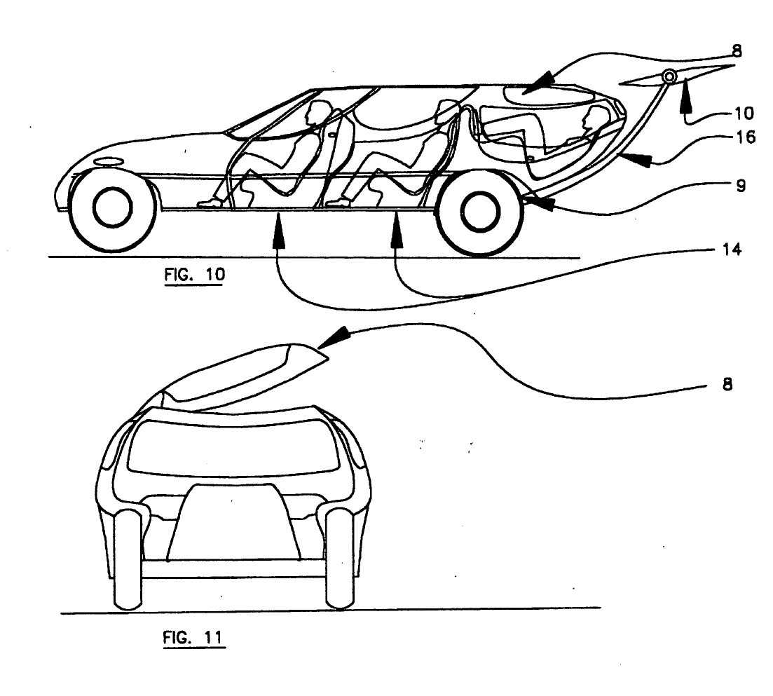

On the sketch of the preferred embodiment on FIG. 9, the rear door(s) 6 open vertically about hinges 7 located along the longitudinal axes in the middle of the car's roof or otherwise at the left side of the fuselage's passenger rear compartment.

Numerous modifications, variations and alterations may be made to the specific embodiment of the invention herein above described, without departing from the scope of the invention as defined as follows:

1. Canceled

2. Canceled

3. A fuselage of an automobile comprising:
said automobile fuselage of an acute angle parallelogram shape in its side cross-section,
a top plate projected horizontally strait backward,
a bottom plate limited by the last row of conventional seats,
a rear wheel booth, placed at the end of bottom plate,
a body rear plate mounted at an acute angle to horizontal axis upward toward fuselage back to be about parallel to the front plate,
rear seats comprising three parts, where first part running from the last conventional seats row about horizontally backward, a second part running down nearly vertically, and a third part running upward to automobile rear about parallel to said automobile fuselage rear plate to be the back of said seats.

4. The fuselage of an automobile of claim 3 further comprising extra conventional seats rows

5. The fuselage of an automobile of claim 3 wherein the wheel booth, placed at a wheel frame extenuation with a space between the wheel booth and the fuselage rear and bottom plates.

6. The fuselage of an automobile of claim 3 further comprising spoilers attached to the top plate.

7. The fuselage of an automobile of claim 3 with the top plate projected backward over the rear plate upper end.

8. The fuselage of an automobile of claim 3 further comprising a vertical chock absorbers with spoiler.

9. The fuselage of an automobile of claim 3 having combined together rear and bottom plates the way the rear half of the bottom plate is slanted upward toward the body's rear.
